(19) United States
(12) Patent Application Publication
(10) Pub. No.: US 2013/0169814 A1
(43) Pub. Date: Jul. 4, 2013

(54) LAMP SOCKET TYPE CAMERA

(71) Applicant: Da-Ming LIU, New Taipei City (TW)

(72) Inventor: Da-Ming LIU, New Taipei City (TW)

(21) Appl. No.: 13/338,302

(22) Filed: Dec. 28, 2011

(51) Int. Cl. H04N 7/18

(52) U.S. Cl. 348/151; 348/E07.085

(57) ABSTRACT

The present invention is to provide a lamp socket type camera which includes an outer housing, a bulb socket connected to the outer housing and capable of being threadedly and electrically connected to an existing lamp socket for receiving electric power from the lamp socket, a power module received in the receiving space and electrically connected to the bulb socket for converting the electric power received from the bulb socket into a required specification, a control module received in the receiving space and connected to the power module, a wireless transmission module received in the receiving space and connected to the control module, and an image capturing element connected to the power module and the control module respectively for capturing image data from outside of the outer housing and transmitting the image data to the control module which will send the image data out via the wireless transmission module wirelessly.

### FIELD OF THE INVENTION

The present invention relates to a camera, more particularly to a lamp socket type camera having a bulb socket capable of being threadedly and electrically connected to an existing lamp socket for receiving electric power from the lamp socket, and an image capturing element capable of capturing image data from outside of the camera and transmitting the image data out via a wireless transmission module wirelessly.

### BACKGROUND OF THE INVENTION

Nowadays, cameras are widely used for remote surveillance. These cameras are typically configured for capturing images and transmitting the captured images in real time and are therefore applicable to production line management, traffic monitoring, and security control. Commonly seen surveillance cameras include the traditional analog cameras, which were favored for their high image quality and stable signal transmission, and the recently popular network cameras. To install an analog camera, it is generally required to use a copper cable whose one end is connected to the analog camera and whose opposite end is connected to an input terminal of a screen. Alternatively, the latter end is connected to a recording device having a hard disk drive, and the recording device is connected to the screen, so as for the recording device to record the images captured by the analog camera, and for the screen to simultaneously display the images transmitted from the analog camera. In either case, surveillance can be carried out by watching the images displayed on the screen.

On the other hand, a network camera is generally installed by connecting one end of a network cable to the network camera and the other end of the network cable to a network device, such as a router. The network camera can connect to a local network or the Internet through the network device, allowing one who uses a computer or the like to connect to the local network or the Internet to obtain the images captured by the network camera. However, in addition to being connected to the aforesaid copper cables or network cables for transmitting image signals, both the analog cameras and the network cameras (hereinafter generally referred to as cameras) must be connected to power sources via power cables in order to obtain the electricity necessary for operation. If no suitable power sources are available where a camera is to be installed, extra time and money must be spent for wiring and for the additional installation of related power equipment, which significantly increases the cost and difficulty of camera installation. Moreover, the camera must be fixed to the ceiling or the wall by means of fasteners (e.g., screws) and tools, which adds to the time and labor required for camera installation. Not only that, the camera, once installed, cannot be readily moved to other installation positions according to practical needs; as a result, the camera only provides limited use and is not convenient enough.

The issue to be addressed by the present invention is to overcome the various drawbacks of the conventional cameras and thereby simplify the camera installation process. In particular, it is desirable that a camera can be rapidly installed without the need to install additional wires, thus reducing the time and money spent. It is further desirable that a camera can be rapidly changed from one installation position to another when needed, thus enhancing the convenience of use of the camera.

### BRIEF SUMMARY OF THE INVENTION

In view of the aforementioned drawbacks of the conventional cameras, the inventor of the present invention conducted extensive research and experiment and finally succeeded in developing a lamp socket type camera as disclosed herein. Compared with the conventional cameras, the lamp socket type camera features a much simpler installation process by which it can be easily installed in a common lamp socket. Therefore, not only does the lamp socket type camera provide enhanced convenience of use, but also the labor and cost conventionally required for additional wiring can be saved.

It is an object of the present invention to provide a lamp socket type camera which includes an outer housing, a bulb socket, a power module, a control module, a wireless transmission module, a sliding housing, and an image capturing element. The outer housing has one side formed with an opening and is provided with a receiving space extending inward from the opening. The bulb socket includes a first electrode and a second electrode and is connected to another side of the outer housing. The bulb socket can be threadedly connected to a lamp socket such that the first and the second electrodes are electrically connected to contacts of the lamp socket. The power module is received in the receiving space and is respectively and electrically connected to the first and the second electrodes so as to convert the electric power transmitted from the first and the second electrodes into electric power having the required power specifications. The control module and the wireless transmission module are received in the receiving space. The control module is separately connected to the wireless transmission module and the power module so as to receive the electric power transmitted from the power module and control the wireless transmission module. The sliding housing has one side formed with a light-permeable aperture. The sliding housing is slidably provided in the receiving space, with the aforesaid side of the sliding housing extending out of the opening. The image capturing element is provided in the sliding housing and corresponds in position to the light-permeable aperture. The image capturing element is connected to the power module so as to obtain the necessary electric power from the lamp socket through the power module and the bulb socket. Also, the image capturing element is connected to the control module and can capture image data from the outside through the light-permeable aperture and transmit the image data to the control module, so as for the control module to send out the image data wirelessly via the wireless transmission module. The lamp socket type camera can be easily installed by connecting it to an existing lamp socket and adjusting the sliding housing and the image capturing element. As such, the camera installation process is substantially simplified.

It is another object of the present invention to provide the foregoing lamp socket type camera, wherein the image capturing element has two opposite sides each protrudingly provided with a pivot pin, and wherein the sliding housing is provided therein with a pivotally connecting portion corresponding in position to each pivot pin. The pivot pins are connected to the pivotally connecting portions respectively such that the image capturing element is pivotally provided in the sliding housing at a position corresponding to the light-permeable aperture and can be freely rotated to the desired image capturing angles.

Yet another object of the present invention is to provide the foregoing lamp socket type camera, wherein the lamp socket type camera further includes a cap. The cap is transparent and covers the sliding housing so as to shield and protect the image capturing element.

Still another object of the present invention is to provide the foregoing lamp socket type camera, wherein the lamp socket type camera further includes a cover. The cover is formed with a through hole and covers the outer housing. The through hole corresponds in position to the opening of the outer housing so as for the cap to pass through the through hole and extend out of the cover. In addition, the sliding housing is protrudingly provided with a projection corresponding in position to the inner wall of the outer housing, and the cover is extended with a stop portion corresponding in position to the through hole. When the sliding housing moves outward of the opening, the stop portion can stop the projection and thereby prevent the sliding housing from coming off the outer housing.

### BRIEF DESCRIPTION OF THE SEVERAL VIEWS OF THE DRAWINGS

The structure as well as a preferred mode of use, further objects, and advantages of the present invention will be best understood by referring to the following detailed description of an illustrative embodiment in conjunction with the accompanying drawings, in which:

FIG. 1 is an exploded perspective view of a preferred embodiment of the present invention;

FIG. 2 is a partially exploded perspective view of the embodiment depicted in FIG. 1; and

FIG. 3 shows the embodiment of FIG. 1 in use.

### DETAILED DESCRIPTION OF THE INVENTION

The inventor of the present invention has long been engaged in the research and development of cameras and related products. In the process, the inventor has found that installation of the conventional cameras is undesirably costly, complicated, and time-consuming not only because power cables and signal transmission lines must be in place before the cameras can be installed, but also because fasteners such as screws are required to fix the cameras to the ceiling or the wall. While attempts have been made to improve the conventional cameras, an ideal solution has yet to be found. In consideration of the above, the inventor came up with the idea of incorporating an existing bulb socket into a camera and thereby making a lamp socket type camera which can be directly installed in a common lamp socket. By substantially simplifying the camera installation process, the time and labor otherwise required can be saved.

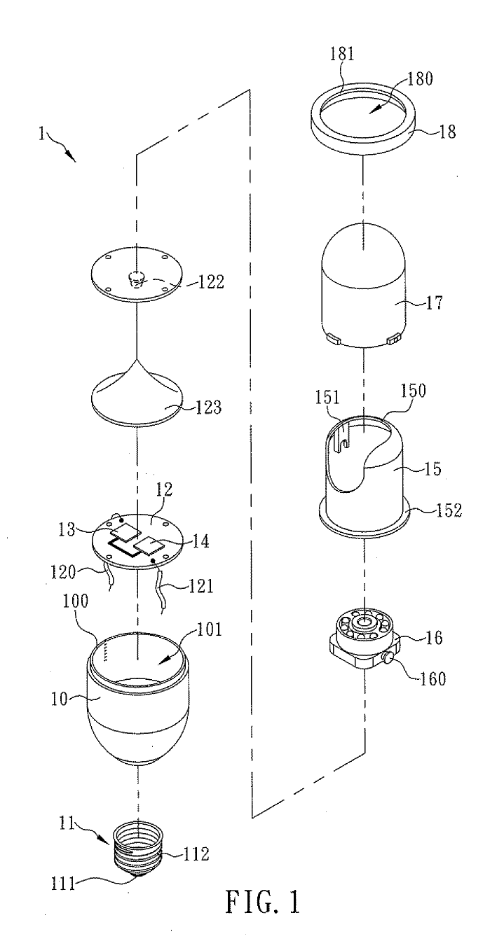

The present invention discloses a lamp socket type camera. Referring to FIG. 1 for a preferred embodiment of the present invention, a lamp socket type camera 1 includes an outer housing 10, a bulb socket 11, a power module 12, a control module 13, a wireless transmission module 14, a sliding housing 15, and an image capturing element 16. The outer housing 10 has one side (e.g., the top side as shown in the drawing) formed with an opening 100. The outer housing 10 also has a receiving space 101 extending inward from the opening 100. The bulb socket 11 includes a first electrode 111 and a second electrode 112 and is connected to another side (e.g., the bottom side as shown in the drawing) of the outer housing 10. The bulb socket 11 can be threadedly connected to a lamp socket (not shown) such that the first and the second electrodes 111, 112 are electrically connected to contacts (not shown) of the lamp socket.

The power module 12 is received in the receiving space 101 and is connected with conductive wires 120, 121. The conductive wire 120 is electrically connected to the first electrode 111, and the conductive wire 121 to the second electrode 112. Upon receiving the electric power transmitted from the first and the second electrodes 111, 112, the power module 12 converts the received electric power into electric power of the required power specifications. In this preferred embodiment, the power module 12 is configured for converting alternating-current (AC) electricity into direct-current (DC) electricity and regulating the input voltage to an appropriate voltage to be supplied to the control module 13, the wireless transmission module 14, and the image capturing element 16. However, the power module 12 is not limited to that described above and can be designed according to practical needs when making the lamp socket type camera 1 of the present invention. All changes easily conceivable by a person skilled in the art should fall within the scope of the present invention.

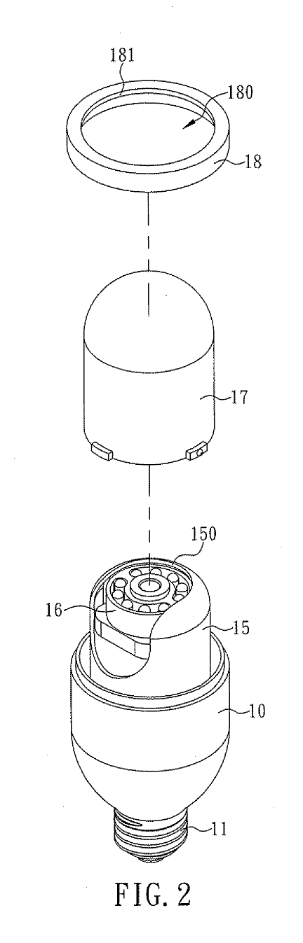

In the preferred embodiment shown in FIG. 1, the control module 13 is a microprocessor, and both the control module 13 and the wireless transmission module 14 are received in the receiving space 101. The wireless transmission module 14 can be a WiFi module, a Bluetooth module, an ultra-wideband (UWB) module, or other modules capable of wireless transmission; the present invention imposes no limitations in this regard. The control module 13, which is separately connected to the wireless transmission module 14 and the power module 12, is configured for receiving the electric power transmitted from the power module 12 and controlling the wireless transmission module 14. The sliding housing 15 has one side formed with a light-permeable aperture 150, wherein the size and shape of the light-permeable aperture 150 may vary depending on user needs or design requirements. The sliding housing 15 is slidably provided in the receiving space 101 such that the aforesaid side of the sliding housing 15 extends out of the opening 100 (see FIG. 2).

Referring again to FIG. 1, the image capturing element 16 has two opposite sides each protrudingly provided with a pivot pin 160 (though only one pivot pin 160 is shown in the drawing). Meanwhile, the sliding housing 15 is provided therein with a pivotally connecting portion 151 corresponding in position to each pivot pin 160 (though only one pivotally connecting portion 151 is shown in the drawing). With the pivot pins 160 respectively connected to the pivotally connecting portions 151, the image capturing element 16 is pivotally provided in the sliding housing 15 at a position corresponding to the light-permeable aperture 15. The structural designs of the pivot pins 160 and the pivotally connecting portions 151 are such that the image capturing element 16 can rotate within the sliding housing 15 to different shooting angles. The image capturing element 16 is connected to the power module 12 to obtain the necessary electric power from the lamp socket through the power module 12 and the bulb socket 11. The image capturing element 16 is also connected to the control module 13. The image capturing element 16 can capture image data from the outside through the light-permeable aperture 150 and transmit the captured image data to the control module 13. The control module 13, in turn, can transmit the image data wirelessly via the wireless transmission module 14. Additionally, referring to FIGS. 1 and 2, the lamp socket type camera 1 is this preferred embodiment includes a cap 17 and a cover 18. The cap 17 is a transparent cap made of plastic or other transparent materials (e.g., glass), and the size and shape of the cap 17 may be modified according to user needs, with a view to meeting market demands. The cap 17 covers the sliding housing 15 to shield and protect the image capturing element 16 from moisture, dust, and dirt. The cover 18, as shown in FIG. 1, is formed with a through hole 180 and covers the outer housing 10, wherein the through hole 180 corresponds in position to the opening 100 of the outer housing 10, thus allowing the cap 17 to extend out of the cover 18 through the through hole 180. The sliding housing 15 is protrudingly provided with a projection 152 corresponding in position to the inner wall of the outer housing 10, and the cover 18 is extended with a stop portion 181 corresponding in position to the through hole 180. When the sliding housing 15 moves outward of the opening 100, the stop portion 181 can stop the projection 152 and thus keep the sliding housing 15 from separating from the outer housing 10. In addition to the foregoing technical features, the outer housing 10 is provided therein with at least one light emitting element 122 (e.g., at least one light emitting diode) as shown in FIG. 1. The light emitting element 122 corresponds in position to a reflective member 123 configured for reflecting the light emitted by the light emitting element 122. If the sliding housing 15 is made of a transparent or translucent material such as acrylic, the light emitted by the light emitting element 122 will shine through the sliding housing 15. It should be pointed out that, while only one light emitting element 122 is shown in FIG. 1 as provided in the outer housing 10, the present invention has no limitations in this respect. The number of the at least one light emitting element 122 may be adjusted according to practical needs.

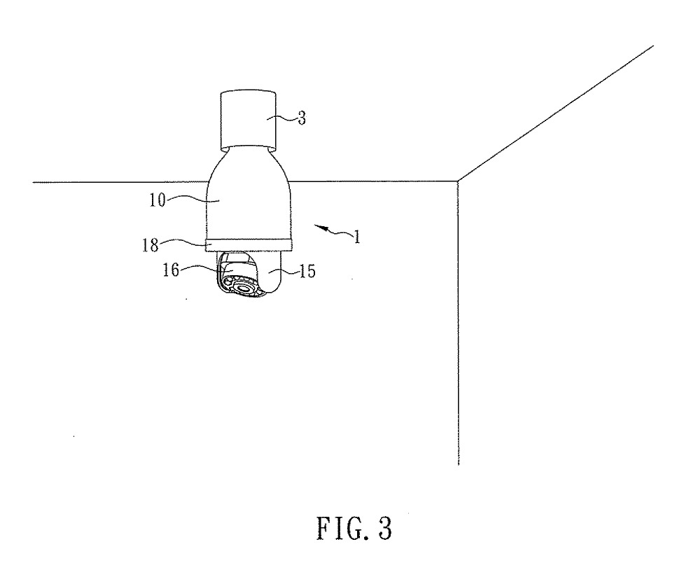

Thanks to the technical features of the present invention, the lamp socket type camera 1 can be installed without additional wiring and can be fixed to the ceiling or the wall without using tools or fasteners such as screws. To install the lamp socket type camera 1, referring to FIG. 3, the user only has to connect the lamp socket type camera 1 threadedly to an existing lamp socket 3, rotate the sliding housing 15 and the image capturing element 16 according to the environment and the desired shooting angle, and adjust the extent to which the sliding housing 15 extends out of the outer housing 10. This camera installation process is substantially simplified in comparison with the prior art. It should be noted that, in order to show the sliding housing 15 and the image capturing element 16, the cap 17 is omitted in FIG. 3. In practice, the cap 17 depicted in FIG. 2 is placed over the sliding housing 15 once angular adjustment of the image capturing element 16 is completed. As soon as the lamp socket type camera 1 is installed in place, the user can use an electronic device with a wireless receiver (e.g., a personal computer or monitor) to receive the image data transmitted from the wireless transmission module 14 (see FIG. 1) and store or display in real time the image data received, thus achieving the objective of surveillance. In short, the technical features of the present invention simplify the camera installation procedure, greatly reduce the time required for camera installation, and by allowing the lamp socket type camera 1 to be installed in the common lamp socket 3, make it possible to rapidly move the lamp socket type camera 1 from one installation position to another to meet user needs. Hence, the flexibility of use of the camera is significantly increased to cope with the needs in various application fields effectively.

While the invention herein disclosed has been described by means of specific embodiments, numerous modifications and variations could be made thereto by those skilled in the art without departing from the scope of the invention set forth in the claims.

What is claimed is:

1. A lamp socket type camera, comprising:
an outer housing having a side formed with an opening, the outer housing further having a receiving space extending inward from the opening;
a bulb socket comprising a first electrode and a second electrode, the bulb socket being connected to another side of the outer housing, the bulb socket being threadedly connectable to a lamp socket such that the first electrode and the second electrode are electrically connected to contacts of the lamp socket;
a power module received in the receiving space, the power module being respectively and electrically connected to the first electrode and the second electrode so as to convert electric power transmitted from the first electrode and the second electrode into electric power of required power specifications;
a wireless transmission module received in the receiving space;
a control module received in the receiving space, the control module being respectively connected to the wireless transmission module and the power module so as to receive electric power transmitted from the power module and control the wireless transmission module;
a sliding housing having a side formed with a light-permeable aperture, the sliding housing being slidably provided in the receiving space such that the side of the sliding housing extends out of the opening; and
an image capturing element provided in the sliding housing and corresponding in position to the light-permeable aperture, the image capturing element being connected to the power module so as to obtain necessary electric power from the lamp socket through the power module and the bulb socket, the image capturing element being connected to the control module and configured for capturing image data from outside through the light-permeable aperture and transmitting the image data to the control module, so as for the control module to transmit the image data wirelessly through the wireless transmission module.

2. The lamp socket type camera of claim 1, wherein the image capturing element has two opposite sides each protrudingly provided with a pivot pin, and the sliding housing is provided therein with a pivotally connecting portion corresponding in position to each said pivot pin, the pivot pins being respectively connected to the pivotally connecting portions such that the image capturing element is pivotally provided in the sliding housing and corresponds in position to the light-permeable aperture.

3. The lamp socket type camera of claim 2, further comprising a cap, wherein the cap is transparent and covers the sliding housing so as to shield and protect the image capturing element.

4. The lamp socket type camera of claim 3, further comprising a cover, wherein the cover is formed with a through hole and covers the outer housing, the through hole corresponding in position to the opening of the outer housing so as for the cap to extends out of the cover through the through hole.

5. The lamp socket type camera of claim 4, wherein the sliding housing is protrudingly provided with a projection corresponding in position to an inner wall of the outer housing, and the cover is extended with a stop portion corresponding in position to the through hole so that, when the sliding housing moves outward of the opening, the stop portion can stop the projection.

6. The lamp socket type camera of claim 5, wherein the outer housing is provided therein with at least a light emitting element.
